(19) United States
(12) Patent Application Publication
(10) Pub. No.: US 2011/0010658 A1
(43) Pub. Date: Jan. 13, 2011

(54) USER INTERFACE SCROLLING

(75) Inventors: Ian Nash, Berkshire (GB); Aki Vanhatalo, Guildford (GB); Alan Wilkinson, London (GB); Edward Guest, Southampton (GB)

Correspondence Address: Perman & Green, LLP, 99 Hawley Lane, Stratford, CT, 06614, US

(73) Assignee: NOKIA CORPORATION, Espoo (FI)

(21) Appl. No.: 12/682,552

(22) PCT Filed: Oct. 12, 2007
(86) PCT No.: PCT/EP07/08892

§ 371 Date: Oct. 1, 2010

(51) Int. Cl. G06F 3/048

(52) U.S. Cl. 715/784

(57) ABSTRACT

A method for displaying data items in a display window, including detecting a user input action, including receiving a first user input signal via user input device, the signal being indicative of a velocity of the user action; and depending on the velocity, entering one of a plurality of display states, in which states a respective number of data items are displayed in the display window is provided. A device and computer program product thereof is also provided.

### CROSS-REFERENCE TO RELATED APPLICATIONS

This application is the National Stage of International Application No. PCT/EP2007/008892 International Filing Date 12 Oct. 2007, which designated the United States of America, and which International Application was published under PCT Article 21 (s) as WO Publication No. WO2009/046743 A1, the disclosure of which is incorporated herein by reference in its entirety.

### BACKGROUND

The aspects of the disclosed embodiments relate to a method and device for displaying data items in a display window.

Mobile communication devices, such as mobile phones or personal digital assistants (PDAs), are today used for many different purposes. Typically, displays are used for output and keypads are used for input, particularly in the case of mobile communication devices.

For large devices, large screens and more refined input mechanisms allow for a rich and intuitive user interface. There is however a problem with user interfaces for small portable electronic devices, where displays are small and user input is limited. Any improvement in the user experience of such devices have an impact on usability and attractiveness.

In this context one particular drawback is the problem a user encounters when desiring to locate a specific item among a large set of items, for example when browsing through a folder of images in order to find a specific image.

Consequently, there is a need for an improved user interface for small portable electronic devices with a limited user interface.

### SUMMARY

In view of the above, one aspect of the disclosed embodiments is to solve or at least reduce the problems discussed above. Generally, the above aspects of the disclosed embodiments are achieved by the attached independent patent claims.

Hence there is provided a method for displaying data items in a display window, comprising detecting a user input action, comprising receiving a first user input signal via a user input device, the signal being indicative of a velocity of the user action; and depending on the velocity, entering one of a plurality of display states, in which states a respective number of data items are displayed in the display window. The displaying in at least one display state may involve displaying the data items during a pre-determined time interval. The data items may be from the group of image files, audio files, text files, multimedia files.

Thus the proposed method allows for a seamless switch from e.g. scrolling and navigating data item per data item to scrolling and navigating a plurality of data items. An advantage of this is that it provides simplicity and speed when a user is operating a device during location of a specific item among a large set of items, for example when browsing through a folder of images in order to find a specific image.

The plurality of states may include at least a first state and a second state, and the reception of the first user input signal may involve during a time period receiving a number of signal units associated with the first user input action; determining the velocity pertaining to the first user input, the velocity being indicative of at least a first velocity and a second velocity; associating the first display state with the first velocity, associating the second display state with the second velocity; and the first display state may comprise displaying one data item; and the second display state may comprise displaying a plurality of data items.

The user interface state switch thus provides a reference to the user as to where they are in their current collection of data items, further accentuating the advantages as discussed above.

The method may further comprise detecting a change in the velocity from the first velocity to the second velocity, and as a result of the change in velocity switch from the first display state to the second display state. The magnitude of the second velocity may be larger than the magnitude of the first velocity.

Thus a user may scroll faster to initiate the application in order to switch from having one data item displayed to having a plurality of data items displayed on his/her display screen.

The method may further comprise, depending on a second user input received during the second display state via a user input device, scrolling at least the displayed data items along a virtual path and highlighting one of the said displayed data items. The highlighting of the displayed data item may be achieved by at least changing the size of the highlighted data item.

The method may further comprise, depending on a second user input received during the second display state via a user input device, scrolling a highlighting indicator along a virtual path, such that the highlighting indicator highlights one of the displayed data items. The highlighting may comprise at least one of: highlighting by changing the size of the highlighted data item, highlighting by changing at least one colour of the highlighted data item, highlighting by changing the spatial image resolution of the highlighted data item, highlighting by framing the highlighted data item.

That is, as users scroll slowly full screen image views are displayed and the data items are displayed in a sequence ordered e.g. according to time and date of capture. As users scroll faster the user interface switches to display several data items and with added information.

In a further aspect there is provided a mobile communication device comprising circuitry configured to detect a user input action, comprising receiving a first user input signal via a user input device, the signal being indicative of a velocity of the user action; and enter one of a plurality of display states depending on the velocity, in which states a respective number of data items are displayed in the display window.

In yet an aspect, there is also provided a computer program product comprising computer program code stored on a computer-readable storage medium which, when executed on a processor, carries out a method for displaying data items in a display window as described above.

### BRIEF DESCRIPTION OF THE DRAWINGS

The above, as well as additional objects, features and advantages of the disclosed embodiments, will be better understood through the following illustrative and non-limiting detailed description of preferred embodiments of the disclosed embodiments, with reference to the appended drawings, where the same reference numerals will be used for similar elements, wherein:

FIG. 1 is a schematic illustration of a cellular telecommunication system, as an example of an environment in which the disclosed embodiments may be applied.

FIG. 2 is a schematic front view illustrating a mobile terminal according to an embodiment.

FIG. 3 is a schematic block diagram representing an internal component, software and protocol structure of the mobile terminal shown in FIG. 2.

FIGS. 4a-b are flow charts illustrating a method for displaying data items in a display window according to different embodiments.

FIG. 5 is a state diagram illustrating a method for switching from a first display state to a second display state according to an embodiment.

FIG. 6 illustrates a switch from a first display view to a second display view according to an embodiment.

FIGS. 7a-b are schematic display views of ways for displaying data items in a display window according to different embodiments.

### DETAILED DESCRIPTION

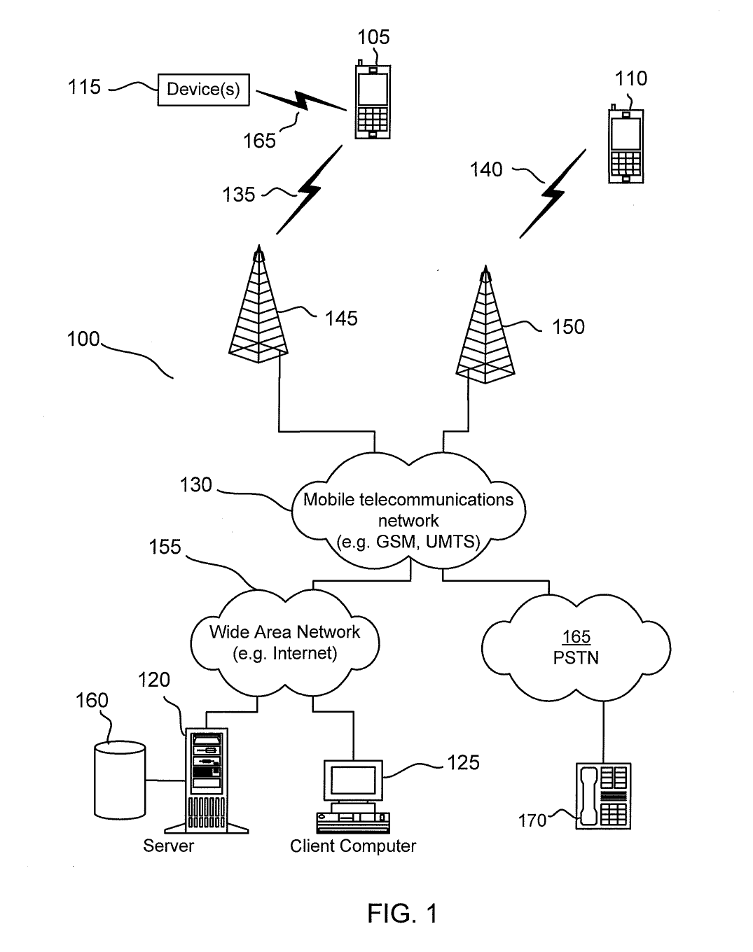

FIG. 1 illustrates an example of a cellular telecommunications system 100 in which the disclosed embodiments may be applied. In the telecommunication system 100 of FIG. 1, various telecommunications services such as cellular voice calls, www/wap browsing, cellular video calls, data calls, facsimile transmissions, music transmissions, still image transmissions, video transmissions, electronic message transmissions, electronic positioning information, and electronic commerce may be performed between a mobile communication device 105 according to the disclosed embodiments and other devices, such as another mobile communication device 110, a local device 115, a computer 120, 125 or a stationary telephone 170. It is to be noted that for different embodiments of the mobile terminal 105 and in different situations, different ones of the telecommunications services referred to above may or may not be available; the disclosed embodiments are not limited to any particular set of services in this respect.

The mobile communication devices 105, 110 are connected to a mobile telecommunications network 130 through RF links 135, 140 via base stations 145, 150. The base stations 145, 150 are operatively connected to the mobile telecommunications network 130. The mobile telecommunications network 130 may be in compliance with any commercially available mobile telecommunications standard, such as GSM, UMTS, D-AMPS, CDMA2000, FOMA and TD-SCDMA.

The mobile telecommunications network 130 is operatively connected to a wide area network 155, which may be Internet or a part thereof. An Internet server 120 has a data storage 160 and is connected to the wide area network 155, as is an Internet client computer 125. The server 120 may host a www/wap server capable of serving www/wap content to the mobile communication devices 105, 110.

A public switched telephone network (PSTN) 165 is connected to the mobile telecommunications network 130 in a familiar manner. Various telephone terminals, including the stationary telephone 170, are connected to the PSTN 165.

The mobile communication device 105 is also capable of communicating locally via a local link 165 to one or more local devices 115. The local link can be any type of link with a limited range, such as Bluetooth, a Universal Serial Bus (USB) link, a Wireless Universal Serial Bus (WUSB) link, an IEEE 802.11 wireless local area network link, an RS-232 serial link, and communications aided by the infrared data association (IrDA) standard, etc.

An embodiment 200 of the mobile communication device 105 is illustrated in more detail in FIG. 2. The mobile communication device 200 comprises an antenna 205, a camera 210, a speaker or earphone 215, a microphone 220, a display 225 (e.g. a touch sensitive display) and a set of keys 230 which may include a keypad of common ITU-T type (alpha-numerical keypad representing characters “0”-“9”, “*” and “#”) and certain other keys such as soft keys, and a joystick or other type of navigational input device, including input devices specifically designed to facilitate easy scrolling of display content. Such a user input device may be a rotational input device or a touch sensitive device on which a user applies pressure along a path etc. The mobile communication device 200 may be e.g. a mobile phone or a personal digital assistant (PDA).

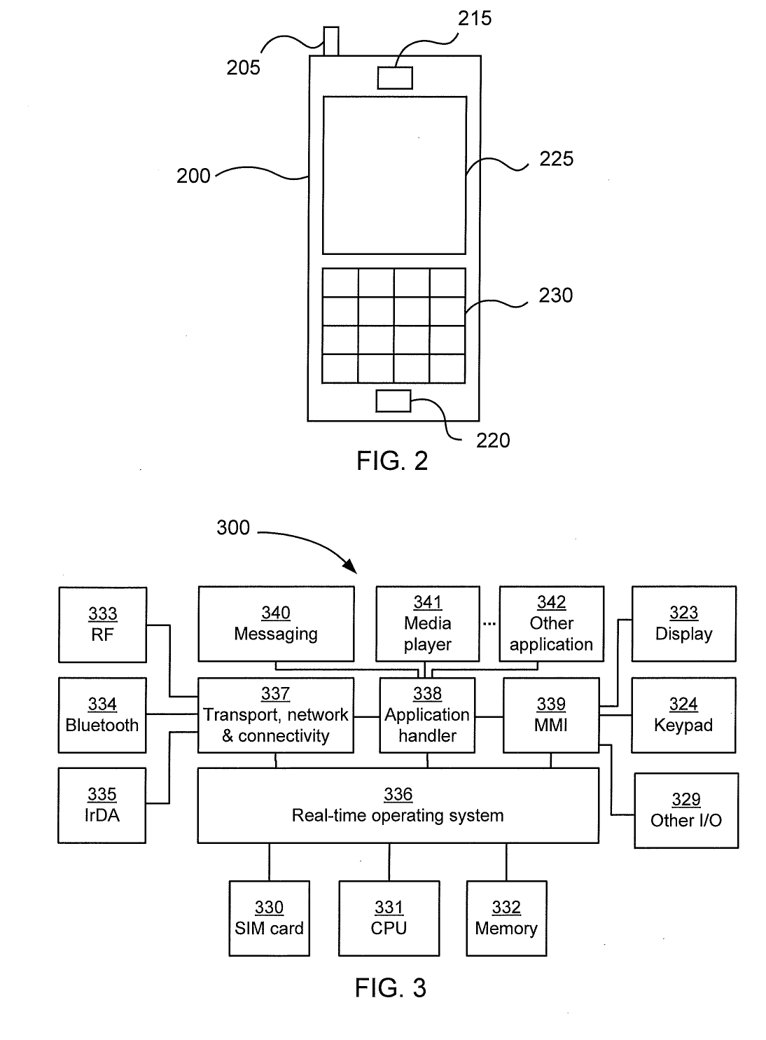

The internal components 300, software and protocol structures of the mobile communication device 200 will now be described with reference to FIG. 3. The mobile communication device has a controller 331 which is responsible for the overall operation of the mobile terminal and is preferably implemented by any commercially available CPU (“Central Processing Unit”), DSP (“Digital Signal Processor”) or any other electronic programmable logic device. The controller 331 has associated electronic memory 332 such as RAM memory, ROM memory, EEPROM memory, flash memory, or any combination thereof. The memory 332 is used for various purposes by the controller 331, one of them being for storing data and program instructions for various software in the mobile terminal, such as data and program instructions corresponding to the disclosed embodiments for scrolling between different data items. The software includes a real-time operating system 336, drivers for a man-machine interface (MMI) 339, an application handler 338 as well as various applications. The applications can include a messaging application 340 for sending and receiving SMS, MMS or email, a media player application 341, as well as various other applications 342, such as applications for voice calling, video calling, web browsing, an instant messaging application, a phone book application, a calendar application, a control panel application, a camera application, one or more video games, a notepad application, a positioning application, etc.

The MMI 339 also includes one or more hardware controllers, which together with the MMI drivers cooperate with the display 323, 225, keypad 324, 230, as well as various other I/O devices 329 such as microphone 220, speaker 215, vibrator, ringtone generator, LED indicator, etc. As is commonly known, the user may operate the mobile terminal through the man-machine interface thus formed.

The software also includes various modules, protocol stacks, drivers, etc., which are commonly designated as 337 and which provide communication services (such as transport, network and connectivity) for an RF interface 333, and optionally a Bluetooth interface 334 and/or an IrDA interface 335 for local connectivity. The RF interface 333 comprises an internal or external antenna as well as appropriate radio circuitry for establishing and maintaining a wireless link to a base station (e.g. the link 135 and base station 145 in FIG. 1). As is well known to a person skilled in the art, the radio circuitry comprises a series of analogue and digital electronic components, together forming a radio receiver and transmitter. These components include, e.g., band pass filters, amplifiers, mixers, local oscillators, low pass filters, AD/DA converters, etc.

The mobile communication device 200 as represented by the internal components 300 in FIG. 3 may also have a SIM card 330 and an associated reader. As is commonly known, the SIM card 330 comprises a processor as well as local work and data memory.

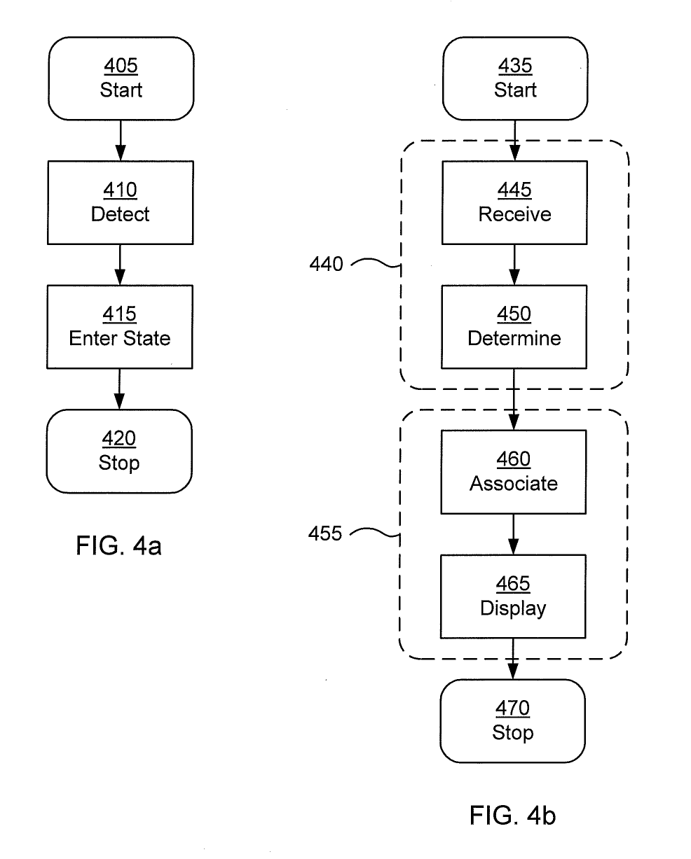

Continuing with FIGS. 4a-b which are flow charts illustrating a method for displaying data items in a display window according to different embodiments. After the application has been initialized 405 the method in FIG. 4a comprises detecting 410 a user input action. The user input action may comprise receiving a first user input via a user input device, e.g. from the keypad 230 or from the display 225, if the display is a touch display, of the mobile communication device 200 in FIG. 2. The detected signal is indicative of a velocity of the user action, the user action e.g, being a scrolling movement of the user input device. Depending on this velocity the method further comprises entering 415 one of a plurality of display states, in which states a respective number of data items are displayed in the display window. As will be further discussed below, each display state is associated with its own characteristic way of displaying the respective number of data items. The application may then be stopped 420.

The flow chart of FIG. 4b describes an embodiment of the method where the steps 410 and 415 of FIG. 4a (in FIG. 4b labeled 440 and 455) are described in more detail. After the application has been initialized 435 the method in FIG. 4b comprises detecting 440 a user input action. The detection comprises during a time period receiving 445 a number of signal units associated with the first user input action. Using the information regarding the number of units and the elapsed time, a velocity pertaining to the number of signal units is determined 450. The velocity is indicative of any of at least a first velocity and a second velocity. A decision is then made such that, depending on the velocity, one of a plurality of display states is entered 455 by associating 460 the first display state with the first velocity, associating 460 the second display state with the second velocity. The first display state comprises displaying 465 one data item and the second display state comprises displaying 465 a plurality of data items, respectively. The application is then stopped 470.

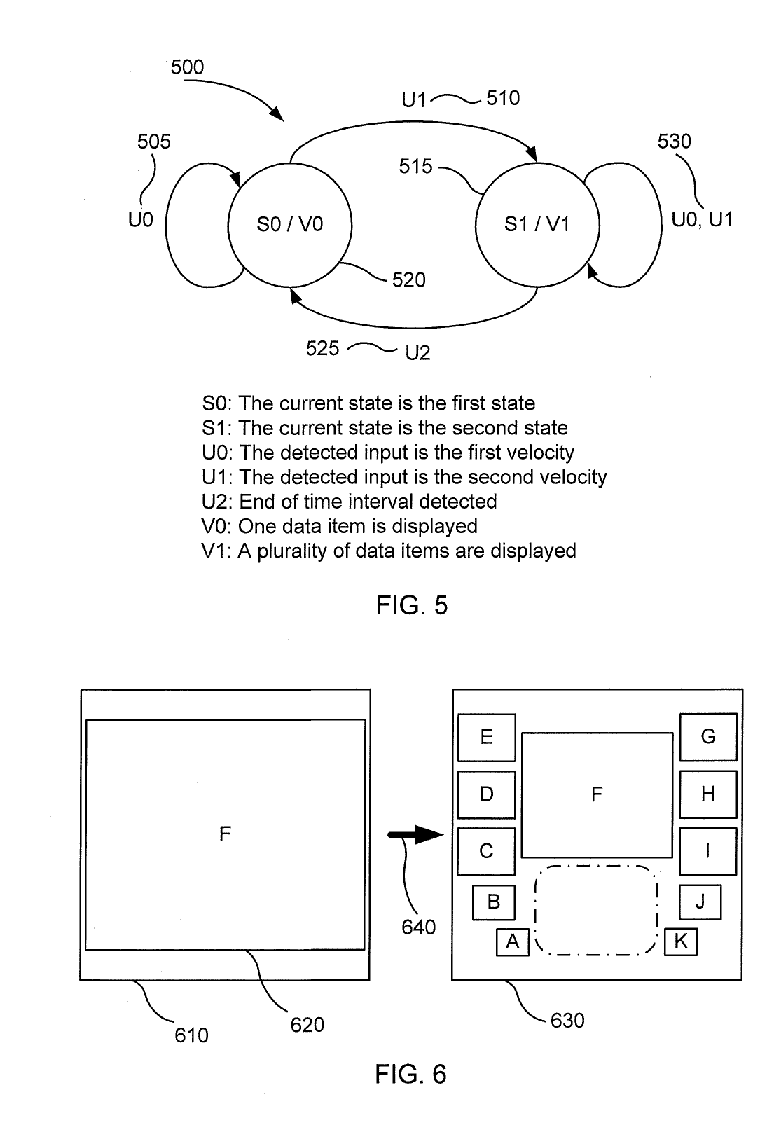

A state diagram 500 in FIG. 5 illustrates a method for switching from a first display state 520 to a second display state 515 according to an embodiment. The state diagram 500 comprises a set of states (schematically labeled “S0” and “S1”), a set of input signals (schematically labeled “U0”,“U1” and “U2”) associated with different detected user input action velocities, a set of output signals (schematically labeled “V0” and “V1”) associated with different display views, and a set of edges, which define the transitions to and from the states “S0”, and “S1”.

The state diagram 500 comprises a first state “S0” and a second state “S1”, each state “S0”, “S1” being associated with a respective output signal “V0”,“V1”.The combination of state and output signal is labeled 520 for the first state and 515 for the second state. In the first display state 520 the display view, as represented by the output signal “V0”, comprises displaying one data item, whereas in the second display state 515 the display view, as represented by the output signal “V1”, comprises displaying a plurality of data items. Each edge is associated with an input action velocity, which velocity is either a first velocity, as represented by the input signal “U0”, or a second velocity, as represented by the input signal “U1”. There is also a special signal “U2” representing a time constraint on the transition from the second state “S1” to the first state “S0”. The input signal “U2” denotes that an end of time interval has been detected.

Without losing generality it can be assumed that the current state is the first state “S0” and thus the current display view is defined by “V0”. If the detected user input action indicates the first velocity, as indicated by “U0” 505, no transition takes place and the method remains in the first state 520, and one data item is displayed as defined by the display view “V0”. Depending on the direction of the user input action (e.g. direction of rotation of input using a rotational input device), and assuming that the data items are ordered in a list, a previous or a next data item from the list may be displayed. If the detected user input action indicates the first velocity, as indicated by “U1” 510, transition takes place to the second state “S1” and a plurality of data items are displayed as defined by the display view “V1”. Thus the application switches from displaying one item to a plurality of data items, e.g., in a tile view (as will be more discussed below). Moreover, the application may stay in the second state 515 for a pre-determined time interval, say in the order of 5-15 seconds, independently of velocity of the user input action (i.e., in the figure indicated by the transition condition “U0, U1” 530). However whilst in the second state, a user may select, scroll, or browse different data items from the plurality of data items. As the pre-determined time interval has elapsed the application transitions from the second state 515 to the first state 520 as indicated by transition condition “U2” 525. The state diagram 500 may extend to include a plurality of display states and a plurality of velocities.

FIG. 6 illustrates a switch from a first display view 610 to a second display view 630 when a transition takes place from the first state to the second state, as described with reference to FIG. 5 above. The leftmost part of the figure shows a schematic display view 610 comprising a display window 620. The display window 620 is associated with a data item, schematically denoted by “F”. The data item may be e.g. an image, an icon representing an audio file, a (portion of a) text message, or a multimedia file. As a change in user input action velocity is detected 640 the display view changes from the first display state to the second display state.

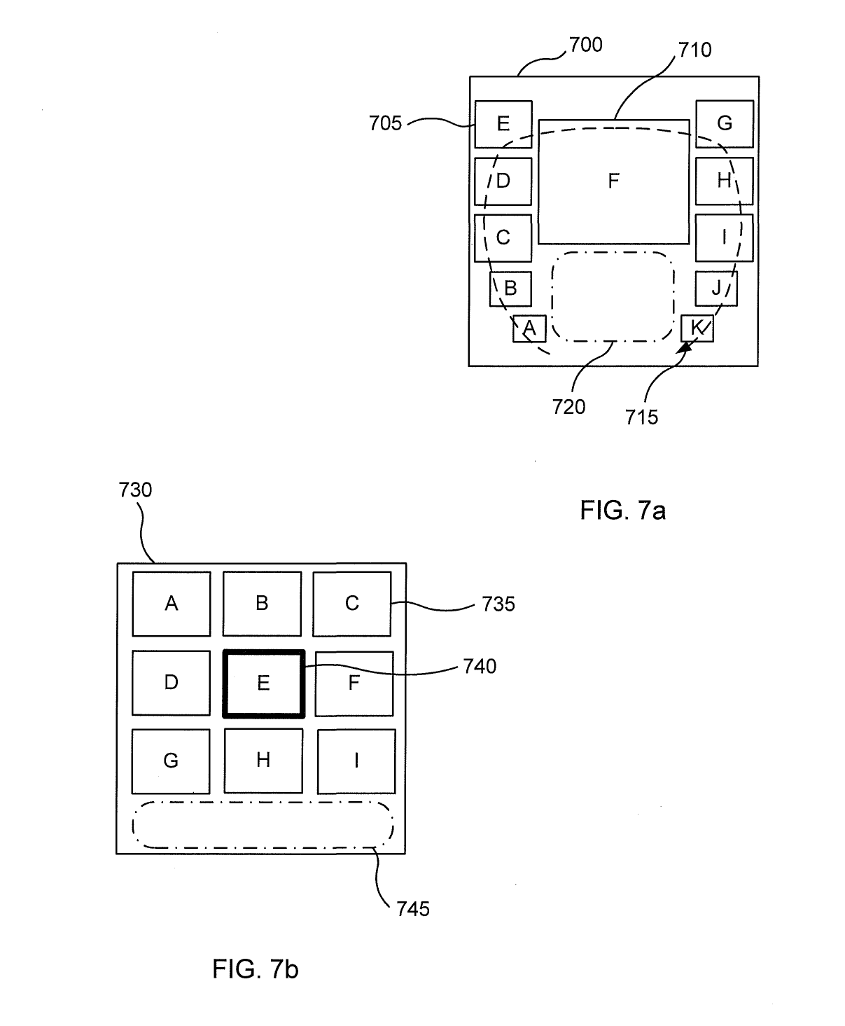

The rightmost part of FIG. 6 shows a schematic display view 630 illustrating a display view associated with the second display state. As can be noted in the figure one data item is displayed in the first display view 610 while a plurality of data items are displayed in the second display view 630. More details regarding the different components of the second display view will be given below with reference to FIGS. 7a and 7b.

FIGS. 7a-b are schematic display views of two ways for displaying a plurality of data items in a display window according to different embodiments. With reference to the state diagram 500 of FIG. 5 and the schematic view in FIG. 6 which illustrates a switch from a first display state to a second display state FIGS. 7a-b represent display views displaying a plurality of data items as associated with the second state of the state diagram 500.

Starting with FIG. 7a which illustrates a schematic display view 700 comprising individual data items 705 (schematically denoted by “A”, “B”, “C”, “D”, “E”, “F” “G”, “H”, “I”, “J”, and “K”), one of which has been highlighted 710 (the data item “F”), and a text window 720 associated with the highlighted data item 710. With reference to the state diagram 500 and FIG. 6 data item “F” corresponds to the one data item associated with the first display state 520 and hence a transition from the first display state 520 to the second display state 515 will switch from a display view displaying only data item “F” to a display view in which data item “F” is the highlighted data item. A switch from the second display state 515 back to the first state 520 will thus display only data item “F”. The text window 720 may be used to show additional information associated with the highlighted data item 710. The individual data items 705 (together with the highlighted data item 710) are displayed along a virtual path 715. As is known to a person skilled in the art the display view 700 may further comprise icons and/or virtual keys.

As a plurality of data items are simultaneously displayed in the display window 700 this view may be denoted a tile view. A user may scroll the individual data items 705 in at least two directions in order to highlight and/or select a specific data item 710 for further processing, such as e.g. viewing, editing, or sending the data item as part of a MMS message. When scrolling in a first direction the individual data items 705 may shift one step to the right along the virtual path 715, that is data item “J” will replace data item “K”, data item “I” will replace data item “J”, and so on. As a consequence of a scrolling to this first direction data item “E” will now be highlighted, and a new data item, which is not shown in the display view 700 will replace data item “A”. A scrolling in a direction opposite to the first direction will have analogous effects. As indicated by the highlighted data item 710 the highlighted data item 710 has been highlighted by means of increasing its size in comparison to the other individual data items 705. However as is known to a person skilled in the art there are other ways to highlight one data item in a plurality of data items.

The schematic display view 730 of FIG. 7b comprises individual data items 735 (schematically denoted by “A”, “B”, “C”, “D”, “E”, “F”, “G”, “H”, “I”, “J”, and “K”), one of which has been highlighted 740 (the data item schematically denoted by “E”), and a text window 745 associated with the highlighted data item 740. Similar to the above, data element “E” corresponds to the only data item displayed in the first display state 520 of the state diagram 500. The text window 745 may be used to show additional information associated with the highlighted data item 740. As is known to a person skilled in the art the display view 730 may further comprise icons and/or virtual keys.

In comparison to FIG. 7a also the display view 730 of FIG. 7a may be referred to as a tile view since it simultaneously displays a plurality of data items. However one difference in comparison to the embodiment of FIG. 7a is that a highlighting indicator is used to highlight a particular data item 740. The highlighting indicator of FIG. 7b highlights data item 740 by means of a frame. In general the highlighting may comprise at least one of: highlighting by changing the size of the highlighted data item 740, highlighting by changing at least one colour of the highlighted data item 740, highlighting by changing the spatial image resolution of the highlighted data item 740, and highlighting by framing the highlighted data item 740. A user may move the highlighting indicator from one data item to another by using a user input device. In FIG. 7b only nine (9) individual data items are displayed. However as is known to a person skilled in the art a new set of a plurality of data items may be displayed if, for example data item “H” is currently highlighted and a user input signal indicates a movement of the highlighting indicator in a direction opposite to the data item “E”.

Below follows a scenario where the disclosed embodiments are used to browse a set of images. However as discussed above the described method applies to browsing data items of any multimedia formats.

Scenario: The multimodality (FIG. 5) of the user interface enables users to both scroll (FIG. 7a), navigate (FIG. 7b) in a traditional manner by just seeing the next or previous image, and having a full image view (leftmost part of FIG. 6). In more detail, if the user scrolling/navigation speed is increased this enables users to scroll/navigate through items quicker with the added benefit of the user interface view now displaying more data items and presenting relevant contextual information. That is, as users scroll slowly full screen image views are displayed and the images are displayed in a sequence ordered e.g. according to time and date of capture. As users scroll faster the user interface switches (FIG. 6) to display several images in a tile view but with added information denoting, for example information regarding month and year of capture (FIGS. 7a-b). Hence the proposed method allows for a seamless switch from scrolling and navigating data item per data item to scrolling and navigating a plurality of data items. The user interface state switch provides a reference to the user as to where they are in their current image collection.

Generally, all terms used in the claims are to be interpreted according to their ordinary meaning in the technical field, unless explicitly defined otherwise herein. All references to “a/an/said/the [device, component, etc]” are to be interpreted openly as referring to at least one instance of said device, component, etc., unless explicitly stated otherwise. The steps of any method disclosed herein do not have to be performed in the exact order disclosed, unless explicitly stated.

The disclosed embodiments have mainly been described above with reference to a few embodiments. However, as is readily appreciated by a person skilled in the art, other embodiments than the ones disclosed above are equally possible within the scope of the disclosed embodiments, as defined by the appended patent claims.

1. A method for displaying data items in a display window, comprising
detecting a user input action, comprising receiving a first user input signal via a user input device, the signal being indicative of a velocity of the user action; and
depending on the velocity, entering one of a plurality of display states, in which states a respective number of data items are displayed in the display window.

2. The method according to claim 1, wherein the displaying in at least one display state involves displaying the data items during a pre-determined time interval.

3. The method according to claim 1, wherein the plurality of states includes at least a first state and a second state, and wherein the reception of the first user input signal involves
during a time period receiving a number of signal units associated with the first user input action;
determining the velocity pertaining to the first user input, the velocity being indicative of any of at least a first velocity and a second velocity;
associating the first display state with the first velocity, associating the second display state with the second velocity; and wherein
the first display state comprises displaying one data item; and
the second display state comprises displaying a plurality of data items.

4. The method according to claim 3, further comprising
detecting a change in the velocity from the first velocity to the second velocity; and
as a result of the change in velocity switch from the first display state to the second display state;

5. The method according to claim 4, wherein
the magnitude of the second velocity is larger than the magnitude of the first velocity.

6. The method according to claim 3, further comprising
depending on a second user input received during the second display state via a user input device, scrolling at least the displayed data items along a virtual path and highlighting one of the said displayed data items.

7. The method according to claim 6, wherein
the highlighting of the displayed data item is achieved by at least changing the size of the highlighted data item.

8. The method according to claim 3, further comprising
depending on a second user input received during the second display state via a user input device, scrolling a highlighting indicator along a virtual path, such that the highlighting indicator highlights one of the displayed data items.

9. The method according to claim 8, wherein the highlighting comprises at least one of: highlighting by changing the size of the highlighted data item, highlighting by changing at least one colour of the highlighted data item, highlighting by changing the spatial image resolution of the highlighted data item, highlighting by framing the highlighted data item.

10. The method according to claim 1, wherein the data items are from the group of image files, audio files, text files, multimedia files.

11. A mobile communication device comprising circuitry configured to
detect a user input action, comprising receiving a first user input signal via a user input device, the signal being indicative of a velocity of the user action; and
enter one of a plurality of display states depending on the velocity, in which states a respective number of data items are displayed in the display window.

12. A computer program product comprising computer program code stored on a computer-readable storage medium which, when executed on a processor, carries out the method according to claim 1.

13. The method according to claim 1, wherein each display state is associated with its own characteristic way of displaying the respective number of data items.

14. The method according claim 1,
wherein scrolling in a first scrolling direction causes individual data items from the respective number of data items to shift in a first data item direction, and
wherein scrolling in a second scrolling direction causes the individual data items to shift in a second data item direction different from the first data item direction.

15. The method according to claim 14, wherein the second data item direction is opposite to the first data item direction.

16. The mobile communication device according to claim 11, further comprising circuitry configured to perform a method for displaying data items in a display window, the method comprising:
detecting a user input action, comprising receiving a first user input signal via a user input device, the signal being indicative of a velocity of the user action; and
depending on the velocity, entering one of a plurality of display states, in which states a respective number of data items are displayed in the display window,
wherein the displaying in at least one display state involves displaying the data items during a pre-determined time interval.
